(19) United States
(12) Patent Application Publication
(10) Pub. No.: US 2007/0215050 A1
(43) Pub. Date: Sep. 20, 2007

(54) Systems and methods for sanitizing egg processing equipment

(75) Inventor: John H. Hebrank, Durham, NC (US)

Correspondence Address: MYERS BIGEL SIBLEY & SAJOVEC, PO BOX 37428, RALEIGH, NC, 27627, US

(73) Assignee: Embrex, Inc.

(21) Appl. No.: 11/374,836

(22) Filed: Mar. 14, 2006

(51) Int. Cl. A01K 45/00

(52) U.S. Cl. 119/6.8

(57) ABSTRACT

Systems and methods for processing sets of eggs with improved sanitation treatment are provided. A method includes obtaining information about a set of eggs to be processed in ovo, and/or determining the number of non-live eggs in the set, selecting a sanitizing treatment for in ovo processing equipment to be used in processing the set of eggs, wherein the selected sanitizing treatment is based on the obtained information and/or number of non-live eggs in the set, processing the set of eggs via the in ovo processing equipment (e.g., injecting a substance into the eggs, and/or removing material from the eggs), and sanitizing the in ovo processing equipment according to the selected sanitizing treatment. A selected sanitizing treatment may include increased frequency and/or duration, increased concentration of sanitizing fluid, applying sanitizing fluid to the shell of the eggs, and/or adding/increasing an antibiotic to a substance injected into the eggs.

### FIELD OF THE INVENTION

The present invention relates generally to eggs and, more particularly, to systems and methods for processing eggs.

### BACKGROUND OF THE INVENTION

Discrimination between poultry eggs on the basis of some observable quality is a well-known and long-used practice in the poultry industry. “Candling” is a common name for one such technique, a term which has its roots in the original practice of inspecting an egg using the light from a candle. As is known to those familiar with eggs, although egg shells appear opaque under most lighting conditions, they are in reality somewhat translucent, and when placed in front of a direct light, the contents of the egg can be observed.

An egg may be a “live” egg, meaning that it has a viable embryo. An egg may be a “clear” or “infertile” egg, meaning that it does not have a viable embryo. More particularly, a “clear” egg is an infertile egg that has not rotted. An egg may be an “early dead” egg, meaning that it has an embryo which died at about one to five days old. An egg may be a “mid-dead” egg, meaning that it has an embryo which died at about five to fifteen days old. An egg may be a “late-dead” egg, meaning that it has an embryo which died at about fifteen to eighteen days old.

An egg may be a “rotted” egg, meaning that the egg includes a rotted infertile yolk (for example, as a result of a crack in the egg's shell) or, alternatively, a rotted, dead embryo. While an “early dead”, “mid-dead” or “late-dead egg” may be a rotted egg, those terms as used herein refer to such eggs which have not rotted. Clear, early-dead, mid-dead, late-dead, and rotted eggs may also be categorized as “non-live” eggs because they do not include a living embryo.

Eggs which are to be hatched to live poultry are typically candled during embryonic development or later to identify non-live eggs and remove them from incubation to thereby increase available incubator space. U.S. Pat. Nos. 4,955,728 and 4,914,672, both to Hebrank, describe a candling apparatus that uses infrared detectors and the infrared radiation emitted from an egg to distinguish live from non-live eggs. U.S. Pat. No. 4,671,652 to van Asselt et al. describes a candling apparatus in which a plurality of light sources and corresponding light detectors are mounted in an array, and wherein eggs are passed on a flat between the light sources and the light detectors.

In many instances, it is desirable to introduce a substance, via in ovo injection, into a live egg prior to hatch. Injections of various substances into avian eggs are employed in the commercial poultry industry to decrease post-hatch mortality rates and/or increase growth rates of hatched birds. Similarly, the injection of virus into live eggs is utilized to propagate virus for use in vaccine preparation. Examples of substances that have been used for, or proposed for, in ovo injection include vaccines, antibiotics and vitamins. Examples of in ovo treatment substances and methods of in ovo injection are described in U.S. Pat. No. 4,458,630 to Sharma et al. and U.S. Pat. No. 5,028,421 to Fredericksen et al.

In ovo injections of substances typically occur by piercing the egg shell to create a hole through the egg shell (e.g., using a punch or drill), extending an injection needle through the hole and into the interior of the egg (and in some cases into the avian embryo contained therein), and injecting the substance through the needle. An example of an injection device designed to inject substances into avian eggs is disclosed in U.S. Pat. No. 4,681,063 to Hebrank. The Hebrank device positions an egg and an injection needle in a fixed relationship to each other, and is designed for the high-speed automated in ovo injection of a plurality of eggs. Alternatively, U.S. Pat. No. 4,458,630 to Sharma et al. describes a bottom (small end) injection machine.

In commercial poultry production, typically only about 60% to 90% of commercial broiler eggs hatch. Eggs that do not hatch include eggs that were not fertilized, as well as rotted eggs, eggs containing pathogens, etc. Adequate cleaning of egg processing equipment, including both in ovo injection equipment and in ovo sampling equipment, is important. The transmission of material from “bad” eggs (e.g., rotted eggs, eggs containing pathogens, etc.) can reduce hatch rates significantly, and/or can significantly compromise embryo health.

Conventional in ovo egg processing equipment typically includes a sanitation system which sprays a sanitizing solution over the injection apparatus that is inserted into an egg. Studies have shown that an injection apparatus inserted into a rotted egg will, when subsequently inserted into live eggs, reduce hatch and/or affect embryo health of multiple live eggs (up to as many as ten eggs), even with normal sanitation procedures. Hatch rates can be improved by increasing the amount of sanitation fluid used and/or increasing flow rates of sanitation fluid and/or by increasing the concentration or composition of sanitizing fluid. Unfortunately, such measures may increase the cost and/or time required for egg processing and may result in an unnecessary amount of sanitizing fluid being used, particularly for egg flocks not containing rotted eggs or eggs with various pathogens. Additionally, the use of more aggressive sanitation fluids may degrade egg processing equipment components.

### SUMMARY OF THE INVENTION

In view of the above discussion, systems and methods for sanitizing egg processing equipment are provided. According to some embodiments of the present invention, a method of processing sets of eggs in ovo, includes obtaining information (stored, real-time, etc.) about a set of eggs to be processed in ovo, selecting a sanitizing treatment for in ovo processing equipment to be used in processing the set of eggs, wherein the selected sanitizing treatment is based on the obtained information, processing the set of eggs via the in ovo processing equipment (e.g., injecting a substance into the eggs, and/or removing material from the eggs), and sanitizing the in ovo processing equipment according to the selected sanitizing treatment. Information obtained about the set of eggs includes, but is not limited to, bird flock location, flock age, date of egg collection, hatchery identification, and historical information about previous egg sets from a respective flock.

According to some embodiments of the present invention, sanitizing in ovo processing equipment includes applying a sanitizing fluid to in ovo processing equipment, and/or to the shells of the eggs prior to processing.

According to some embodiments of the present invention, selecting a sanitizing treatment includes selecting a sanitizing treatment with increased treatment frequency and/or duration, selecting a sanitizing fluid with an increased concentration of sanitizer and/or amount of sanitizing fluid, and/or selecting a sanitizing fluid with an adjusted chemistry and/or temperature.

According to some embodiments of the present invention, a substance injected into eggs may include antibiotic material, and selecting a sanitizing treatment may further include increasing the amount of antibiotic material in the substance.

According to some embodiments of the present invention, a method of processing sets of eggs in ovo, includes candling a set of eggs to identify non-live eggs (or, for example, to identify eggs likely to contain pathogens or contaminants), selecting a sanitizing treatment for in ovo processing equipment to be used in processing the set of eggs, wherein the selected sanitizing treatment is based on the number of non-live eggs identified in the set, processing the set of eggs via the in ovo processing equipment (e.g., injecting a substance into the eggs, and/or removing material from the eggs), and sanitizing the in ovo processing equipment according to the selected sanitizing treatment. Candling may include, for example, measuring opacity of the eggs, measuring temperature of the eggs, spectral candling, detecting embryo pulse rate, and/or detecting embryo motion, etc.

According to some embodiments of the present invention, an egg processing system includes a candling apparatus that identifies live, non-live, and/or contaminant-prone eggs in a set, a plurality of in ovo devices configured to be inserted into the eggs and inject substances and/or remove material from the eggs, and a sanitizer configured to sanitize the plurality of in ovo devices, wherein the sanitizer selects a sanitizing treatment for the in ovo devices based on the number of non-live eggs identified in the set. The candling apparatus may be configured to measure the opacity of each egg in the set at one or more wavelengths, to measure the temperature of each egg in the set, to perform spectral candling on each egg in the set, to detect pulse rate of each egg in the set, and/or to detect embryo motion for each egg in the set. The sanitizer may select a sanitizing treatment such as increasing treatment frequency and/or duration, increasing the concentration of sanitizer in the sanitizing fluid, and/or increasing the amount of sanitizing fluid, and/or adjusting the chemistry and/or temperature of the sanitizing fluid.

According to some embodiments of the present invention, selection of a sanitizing treatment may be performed by an operator or by another component of an egg processing system. For example, an operator may determine, based on, for example, observation of a set of eggs, that a particular sanitizing treatment (e.g., extra sanitizing) is required and may select the particular sanitizing treatment.

According to some embodiments of the present invention, the in ovo devices are injection devices configured to inject a substance into the eggs. The substance includes an antibiotic material, and the injection devices are configured to increase the amount of an antibiotic material in the substance based on the number of non-live eggs identified in the set.

According to some embodiments of the present invention, the injection devices may be configured to perform a partial dispense of sanitation fluid to clear possible contaminants from the fluid remaining in the tips of the injection devices.

### BRIEF DESCRIPTION OF THE DRAWINGS

FIGS. 1-3 are flow charts of operations for processing sets of eggs in ovo, wherein sanitation treatment is selected based on information about each set of eggs, according to some embodiments of the present invention.

FIGS. 4-6 are flow charts of operations for processing sets of eggs in ovo, wherein sanitation treatment is selected based on the number of non-live eggs in each set of eggs, according to some embodiments of the present invention.

FIG. 7 is a partial cross-sectional view of the punch and needle portion of an in ovo injection tool, according to some embodiments of the present invention.

FIG. 8 is a block diagram of an egg processing system, according to some embodiments of the present invention.

### DETAILED DESCRIPTION OF THE INVENTION

The present invention now is described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise. All publications, patent applications, patents, and other references mentioned herein are incorporated herein by reference in their entireties.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a “first” element, component, region, layer or section discussed below could also be termed a “second” element, component, region, layer or section without departing from the teachings of the present invention. The sequence of operations (or steps) is not limited to the order presented in the claims or figures unless specifically indicated otherwise.

As used herein, the terms “injection” and “injecting” encompass methods of inserting a device into an avian egg or embryo, including methods of delivering or discharging a substance into an egg or embryo, methods of removing a substance (i.e., a sample) from an egg or embryo, and/or methods of inserting a detector device into an egg or embryo.

Methods and apparatus according to embodiments of the present invention may be practiced with any type of avian egg, including, but not limited to, chicken, turkey, duck, geese, quail, ostrich, emu, squab, game hen, pheasant eggs, etc.

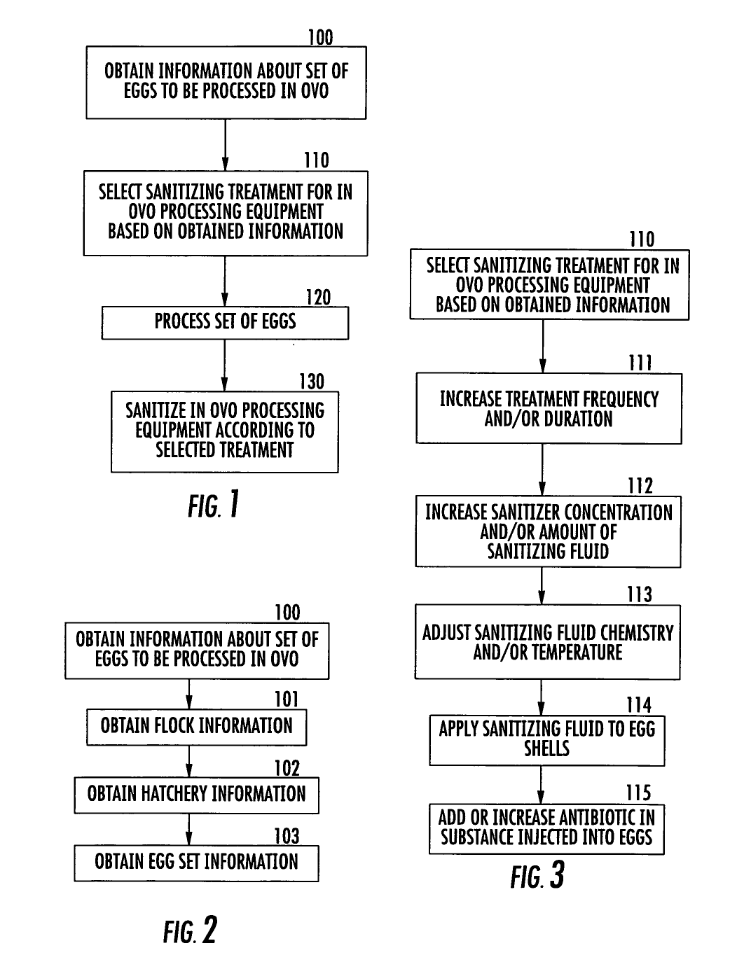

Referring to FIGS. 1-3, a method of processing eggs in ovo, according to some embodiments of the present invention, includes obtaining information about a set of eggs to be processed in ovo (Block 100), selecting a sanitizing treatment for in ovo processing equipment to be used in processing the set of eggs based on the obtained information (Block 110), processing the set of eggs via the in ovo processing equipment (Block 120), and sanitizing the in ovo processing equipment according to the selected sanitizing treatment (Block 130).

Obtaining information about a set of eggs (Block 100), includes obtaining information about the flock of birds that produced the eggs (Block 101, FIG. 2), and/or obtaining information about the hatchery in which the eggs are being processed (Block 102, FIG. 2), and/or obtaining information about the eggs being processed (Block 103, FIG. 2). Flock information includes, but is not limited to, flock location, flock age, date of egg collection, and historical information about previous sets of eggs produced by the flock. Hatchery information includes, but is not limited to, hatchery identification, and historical information about previous sets of eggs processed by the hatchery. Egg information may include, but is not limited to, information about egg shell strength, cracks, number of rotted eggs, number of mid-dead or late-dead eggs, visual appearance to an observer (i.e., operator), etc.

For egg sets produced by older flocks or by flocks that have historically produced a certain number of eggs that become rotted and/or that contain pathogens or contaminants, it may be desirable to increase the intensity of sanitizing treatment applied to the egg processing equipment. For example, an increased amount of sanitizing fluid and/or a sanitizing fluid with increased concentration may be applied to egg processing equipment after eggs from a particular flock have been processed (i.e., in ovo injection and/or in ovo material removal, etc.).

In ovo processing equipment includes devices for injecting a substance(s) into eggs and/or removing material from eggs. An exemplary in ovo processing system that may be utilized to inject substances into eggs and/or remove material from eggs, in accordance with embodiments of the present invention, is the INOVOJECT® automated injection device (Embrex, Inc., Research Triangle Park, N.C.). However, embodiments of the present invention may be utilized with any in ovo processing device.

After in ovo processing of an egg via an in ovo processing device, it is conventional to apply a sanitizing fluid to portions of the in ovo processing equipment that were inserted into an egg. This may include, for example, spraying the sanitizing fluid onto portions of the in ovo processing equipment and/or dipping portions of the in ovo processing equipment in a sanitizing fluid and/or flowing sanitizing fluid onto portions of the in ovo processing equipment.

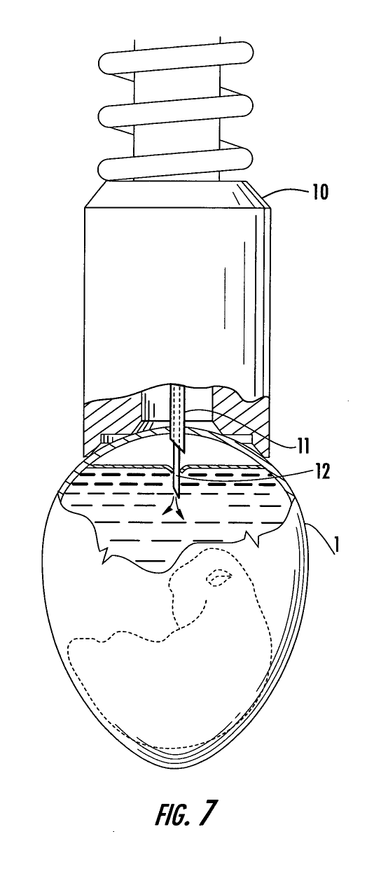

FIG. 7 illustrates a portion of an injection tool 10 of the INOVOJECT® automated injection device. The injection tool 10 includes a punch 11 configured to form an opening in the shell of an egg 1. An injection needle 12 is movably disposed within the punch 11 (i.e., the punch 11 substantially concentrically surrounds the respective needle 12) so that after the punch 11 makes an opening in the shell of an egg, the injection needle 12 can move through the punch 11 and respective opening of an egg shell to an injecting position within an egg for delivery of a substance(s) therein (and/or removal of material therefrom). See, for example, U.S. Pat. No. RE35,973. However, various types of injection tools may be utilized in accordance with embodiments of the present invention. Embodiments of the present invention are not limited to the illustrated injection tool.

After injection of a substance into an egg (and/or removal of material from an egg) via the injection tool 10 of FIG. 7, for example, portions of the punch and needle 11, 12 are treated with a sanitizing fluid, for example, via spraying, dipping, allowing sanitizing fluid to flow through the needle and/or punch, etc. Exemplary sanitizing fluids include, but are not limited to, hypochlorite solutions, sodium hydroxide solutions, hydrogen peroxide solutions, and ozonated water.

Selecting a sanitizing treatment for the in ovo processing equipment (Block 110), according to some embodiments of the present invention, may include increasing the frequency and/or duration (i.e., the length of time) of sanitizing treatment (Block 111, FIG. 3). For example, rather than a single application of sanitizing fluid, two or more applications of sanitizing fluid may be performed. As another example, rather than applying sanitizing fluid for a normal time period, sanitizing fluid may be applied for additional time periods (e.g., double time period, etc.).

Selecting a sanitizing treatment for the in ovo processing equipment (Block 110), according to some embodiments of the present invention, may include increasing the sanitizer concentration in the sanitizing fluid and/or increasing the amount of sanitizing fluid (Block 112, FIG. 3) and/or otherwise adjusting the chemistry and/or temperature of the sanitizing fluid (Block 113, FIG. 3). Hypochlorite solutions of between about 500 ppm-10,000 ppm (parts per million) may be utilized, with the most common being between about 2,000 ppm-5,000 ppm. Increasing the temperature of some sanitizing fluids may cause the sanitizing fluid to become more aggressive, similar to increasing the concentration.

Selecting a sanitizing treatment for the in ovo processing equipment (Block 110), according to some embodiments of the present invention, may include applying sanitizing fluid to the portion of the egg shell through which an in ovo device is to be inserted prior to insertion thereof (Block 114, FIG. 3).

Selecting a sanitizing treatment for the in ovo processing equipment (Block 110), according to some embodiments of the present invention, may include adding (or increasing the amount of) an antibiotic in a substance to be injected into an egg (Block 115, FIG. 3). Adding or increasing an antibiotic material may be performed in conjunction with one or more of the other steps of FIG. 3.

Selecting a sanitizing treatment for the in ovo processing equipment (Block 110), according to some embodiments of the present invention, may include any combination of two or more of the steps of FIG. 3.

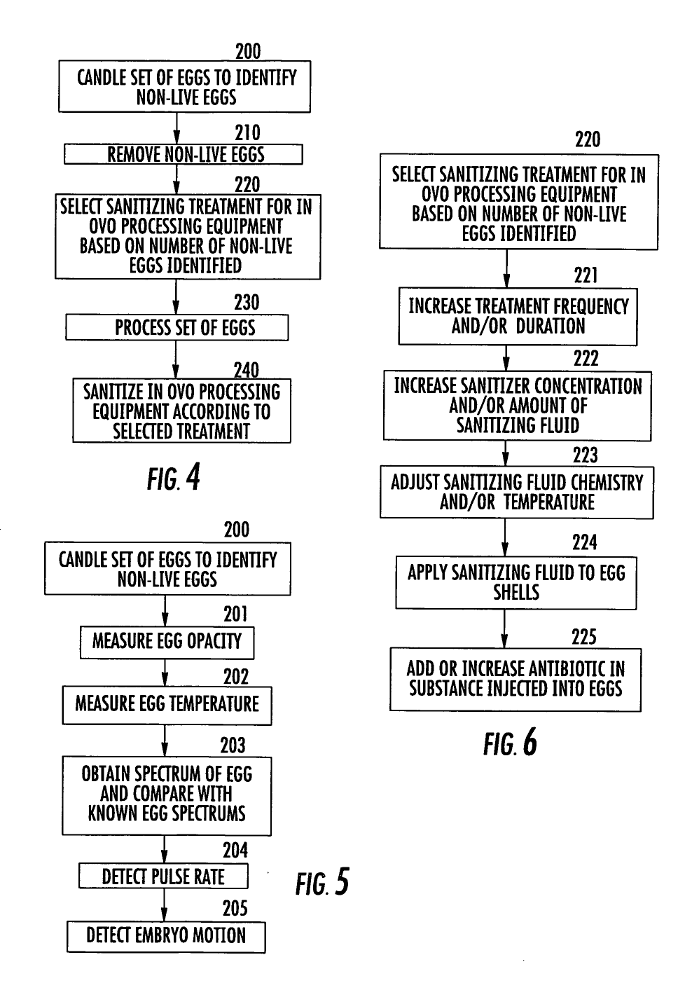

Referring to FIGS. 4-6, a method of processing eggs in ovo, according to some embodiments of the present invention, includes candling a set of eggs to identify non-live eggs (Block 200), removing non-live eggs (Block 210), selecting a sanitizing treatment for in ovo processing equipment to be used in processing the set of eggs based on the number of non-live eggs identified (Block 220), processing the set of eggs via the in ovo processing equipment (Block 230), and sanitizing the in ovo processing equipment according to the selected sanitizing treatment (Block 240).

Various candling operations known to those skilled in the art may be utilized to carry out operations represented by Block 200. For example, as illustrated in FIG. 5, candling (Block 200) may include light candling to determine egg opacity (Block 201), thermal candling to determine egg temperature (Block 202), spectral candling (Block 203), detecting embryo pulse rate (Block 204), or detecting embryo motion (Block 205). Moreover, candling (Block 200) may include combinations of one or more candling operations (i.e., Blocks 201-205) and/or other operations known to those skilled in the art. For example, candling (Block 200) may include a combination of light and thermal candling, for example as described in U.S. Pat. No. 6,234,320 to Hebrank.

As is known to those skilled in the art, light candling involves measuring the opacity of an egg by illuminating the egg with light from a light source, and measuring the amount of light passing through the egg at a detector positioned adjacent the egg. An exemplary light candling system that may be utilized in accordance with some embodiments of the present invention is described in U.S. Pat. No. 5,745,228 to Hebrank et al. A suitable commercial light candling system includes the Pulse Light candling system of the Vaccine Saver™ vaccine delivery system available from Embrex, Inc. of Research Triangle Park, N.C.

As is known to those skilled in the art, thermal candling involves measuring the temperature of an egg. An exemplary thermal candling system that may be utilized in accordance with some embodiments of the present invention is described in U.S. Pat. No. 4,914,672 and in U.S. Pat. No. 4,955,728, each to Hebrank. An exemplary light and thermal candling system is described in U.S. Pat. No. 6,234,320 to Hebrank. Other suitable devices for measuring the opacities of eggs and/or measuring temperatures of eggs may be used in accordance with embodiments of the present invention. Such other suitable devices will be apparent to those skilled in the art from reading the description herein.

As is known to those skilled in the art, spectral candling (Block 203) involves illuminating an egg with light from one or more light sources (e.g., visible and/or infrared light source, etc.) and then receiving light passing through the egg at a detector positioned adjacent the egg. Intensity of the received light is determined at a selected wavelength(s) for the egg and a spectrum is generated that represents light intensity at the selected wavelength(s). The spectrum generated for the egg is then compared with a spectrum associated with types of eggs (e.g., live eggs, non-live eggs, eggs containing pathogens, rotted eggs, cracked eggs, inverted eggs, etc.) to identify whether the egg is a particular type of egg (i.e., whether the egg is live, non-live, contains a pathogen, is rotted, is cracked, is inverted, etc.). For example, if the egg has a spectrum that substantially matches the spectrum associated with a non-live egg, the egg is designated as a non-live egg. Exemplary spectrum generation and analysis methods and apparatus are described in U.S. Pat. No. 6,535,277 to Chalker et al. However, other methods and apparatus may be utilized.

Exemplary methods and apparatus for detecting embryo pulse rate and/or motion, in accordance with some embodiments of the present invention, are described in U.S. Pat. No. 6,860,225 to Hebrank. However, other methods and apparatus may be utilized.

Selecting a sanitizing treatment for the in ovo processing equipment based on the number of non-live eggs identified in a set (Block 220), according to some embodiments of the present invention, may include increasing the frequency and/or duration (i.e., the length of time) of sanitizing treatment (Block 211, FIG. 6). For example, rather than a single application of sanitizing fluid, two or more applications of sanitizing fluid may be performed.

Selecting a sanitizing treatment for the in ovo processing equipment (Block 220), according to some embodiments of the present invention, may include increasing the sanitizer concentration in the sanitizing fluid and/or increasing the amount of sanitizing fluid (Block 222, FIG. 6) and/or otherwise adjusting the chemistry and/or temperature of the sanitizing fluid (Block 223, FIG. 6). Hypochlorite solutions of between about 500 ppm-10,000 ppm (parts per million) may be utilized, with the most common being between about 2,000 ppm-5,000 ppm. Increasing the temperature of sanitizing fluid may cause the sanitizing fluid to become more aggressive, similar to increasing the concentration.

Selecting a sanitizing treatment for the in ovo processing equipment (Block 220), according to some embodiments of the present invention, may include applying sanitizing fluid to the portion of the egg shell through which an in ovo device is to be inserted prior to insertion thereof (Block 224, FIG. 6).

Selecting a sanitizing treatment for the in ovo processing equipment (Block 220), according to some embodiments of the present invention, may include adding (or increasing the amount of) antibiotic material in a substance to be injected into an egg (Block 225, FIG. 6). Adding or increasing antibiotic material may be performed in conjunction with one or more of the other steps of FIG. 6.

Selecting a sanitizing treatment for the in ovo processing equipment (Block 220), according to some embodiments of the present invention, may include any combination of two or more of the steps of FIG. 6.

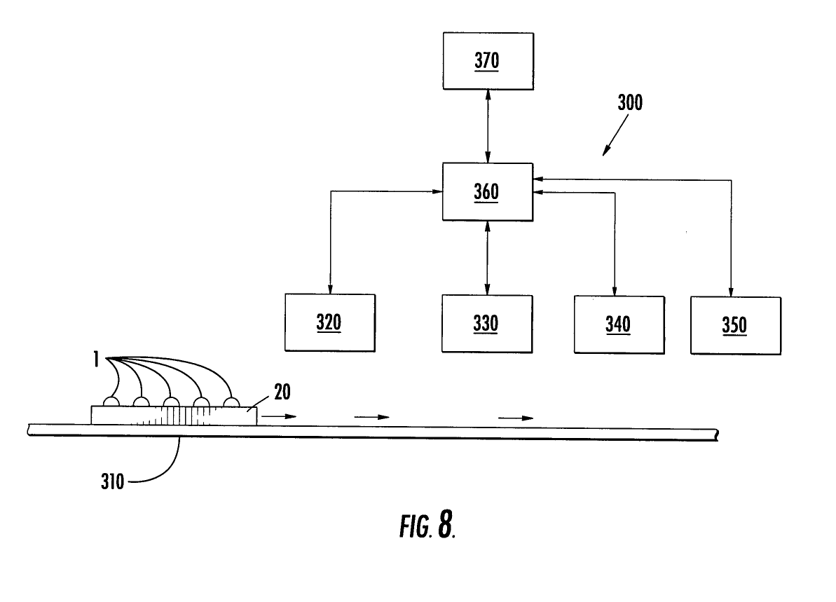

Referring to FIG. 8, a block diagram of an egg processing system 300, according to some embodiments of the present invention, is illustrated. The illustrated egg processing system 300 includes a conveyor system 310 that conveys flats (or other containers) 20 of eggs 1, a candling station 320 operably associated with the conveyor system 310 that identifies live/non-live eggs, an egg removal station 330 that is configured to selectively remove eggs (e.g., live or non-live eggs) from an egg flat 20, an egg processing station 340, and a sanitizing station 350 configured to apply a sanitizing treatment to the in ovo devices of the egg processing station 340.

In operation, a flat 20 of eggs 1 is conveyed via the conveyor system 310 to the candling station 320 that is configured to designate each egg 1 within the flat 20 as being either live or non-live based upon one or more of the above-described techniques (e.g., light candling, thermal candling, spectral candling, detection of embryo pulse and/or embryo motion, etc.). Various types of conveyor systems may be utilized with embodiments of the present invention. Egg conveying systems are well known to those of skill in the art and need not be described further herein.

Although sets of eggs conventionally are carried in egg flats, any type of container for carrying eggs to the candling station 320, as well as to the other egg processing equipment, may be utilized. Egg flats of virtually any type may be used in accordance with embodiments of the present invention. Flats may contain any number of rows, such as seven rows of eggs, with rows of six and seven being most common. Moreover, eggs in adjacent rows may be parallel to one another, as in a “rectangular” flat, or may be in a staggered relationship, as in an “offset” flat. Examples of suitable commercial flats include, but are not limited to, the “CHICKMASTER 54” flat, the “JAMESWAY 42” flat and the “JAMESWAY 84” flat (in each case, the number indicates the number of eggs carried by the flat). Egg flats are well known to those of skill in the art and need not be described further herein.

A controller 360 controls operations of the candling station 320 and stores information about each egg 1 (e.g., whether each egg is live or non-live, or contains, or is likely to contain, a pathogen or other contaminant, etc.). According to some embodiments of the present invention, the controller 360 also is configured to obtain information (e.g., flock location, flock age, date of egg collection, hatchery identification, and historical information about previous sets from a respective flock, etc.) about a set of eggs to be processed and, based upon that information, selects a sanitizing treatment for the equipment of the egg processing station 340. For example, the controller 360 may utilize information from a bar-code or other identifier on the egg flat 20 to select a sanitizing treatment. The controller 360 may obtain information from a database or other source (local or remote; stored or real-time) of information about the set of eggs. The controller 360 may be configured to obtain information about a set of eggs from a remote source via a network, such as, for example, the Internet. According to some embodiments of the present invention, the controller 360 selects a sanitizing treatment for the equipment of the egg processing station 340 based on the number of non-live eggs and/or eggs likely to contain pathogens identified in a set of eggs by the candling station 320. The controller 360 may select a sanitizing treatment for the equipment of the egg processing station 340 based on a variety of information available from the candling station 320.

An operator interface (e.g., a display) 370 may be provided to allow an operator to interact with the controller 360. An operator may select, via the operator interface 370, a sanitizing treatment for the equipment of the egg processing station 340 based on information available to the operator. For example, the operator may observe that a set of eggs likely contains rotted eggs and/or an unusual number of dead or pathogenic eggs and, in response, selects, via the operator interface 370 (or other instrumentation and/or control), a sanitizing treatment for the equipment of the egg processing station 340 (e.g., increase frequency and/or time of sanitizing treatment, increase concentration of sanitizing fluid, etc.).

The controller 360 may control other egg processing operations, as well, including the conveyor system 310, the egg removal station 330, and the egg processing station 340.

Eggs designated as non-live (or designated as likely to contain pathogens or contaminants, etc.) may be removed from the flat 20 via egg removal station 330. The egg removal station 330 may be a manual station wherein the designated non-live eggs are removed by hand. Alternatively, the egg removal station 330 may operate automatically and robotically. For example, the egg removal station 330 may employ suction-type lifting devices as disclosed in U.S. Pat. No. 4,681,063 or in U.S. Pat. No. 5,017,003. Various devices and methods for automatically and robotically removing eggs from a flat and transporting same to another location may be utilized with embodiments of the present invention without limitation. Exemplary egg removal apparatus that may serve the function of the egg removal station 330 are described in U.S. Pat. Nos. 6,145,668; 6,149,375; 6,213,709; and 6,224,316.

Eggs identified as non-live (or that are identified as likely to contain pathogens or contaminants, etc.) are removed from the flat 20 at the egg removal station 330 and are discarded or may be subjected to other processing. Flat 20 at this point on the conveyor 310 contains only live eggs and can proceed to processing station 340 (e.g., inoculation, vaccine production, material sampling, etc.). An exemplary processing station 340 is the INOVOJECT® automated injection system (Embrex, Inc., Research Triangle Park, N.C.). However, various other processing stations capable of in ovo delivery and/or removal may be used in accordance with some embodiments of the present invention.

According to some embodiments of the present invention, selection of a sanitizing treatment may be performed by an operator or by another component of the egg processing system 300.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. A method of processing sets of eggs in ovo, wherein each set of eggs is produced by a respective flock of birds, the method comprising:
obtaining information about a set of eggs to be processed in ovo; and
selecting a sanitizing treatment for in ovo processing equipment to be used in processing the set of eggs, wherein the selected sanitizing treatment is based on the obtained information.

2. The method of claim 1, further comprising:
processing the set of eggs via the in ovo processing equipment; and
sanitizing the in ovo processing equipment according to the selected sanitizing treatment.

3. The method of claim 1, wherein obtaining information comprises obtaining information selected from the group consisting of: flock location, flock age, date of egg collection, hatchery identification, historical information about previous sets from a respective flock, and operator observation.

4. The method of claim 2, wherein sanitizing the in ovo processing equipment comprises applying a sanitizing fluid to the in ovo processing equipment.

5. The method of claim 1, wherein selecting a sanitizing treatment comprises selecting a sanitizing treatment with increased treatment frequency and/or duration.

6. The method of claim 4, wherein selecting a sanitizing treatment comprises selecting a sanitizing fluid with an increased concentration and/or quantity.

7. The method of claim 4, wherein selecting a sanitizing treatment comprises selecting a sanitizing fluid with an adjusted chemistry and/or adjusted temperature.

8. The method of claim 1, wherein selecting a sanitizing treatment comprises selecting a sanitizing treatment wherein sanitizing fluid is applied to shells of the set of eggs.

9. The method of claim 1, wherein processing the set of eggs via the in ovo processing equipment comprises injecting a substance into the eggs.

10. The method of claim 9, wherein the substance includes an antibiotic, and wherein selecting a sanitizing treatment comprises increasing the amount of antibiotic in the substance.

11. The method of claim 2, wherein processing the set of eggs via the in ovo processing equipment comprises extracting material from the eggs.

12. A method of processing sets of eggs in ovo, wherein each set of eggs is produced by a respective flock of birds, the method comprising:
candling a set of eggs to identify non-live eggs; and
selecting a sanitizing treatment for in ovo processing equipment to be used in processing the set of eggs, wherein the selected sanitizing treatment is based on the number of non-live eggs identified in the set.

13. The method of claim 12, further comprising:
processing the set of eggs via the in ovo processing equipment; and
sanitizing the in ovo processing equipment according to the selected sanitizing treatment.

14. The method of claim 12, further comprising removing eggs identified as being non-live prior to processing the set of eggs.

15. The method of claim 12, further comprising obtaining information about the set of eggs, and wherein selecting a sanitizing treatment further includes selecting a sanitizing treatment based on the obtained information.

16. The method of claim 15, wherein obtaining information comprises obtaining information selected from the group consisting of: flock location, flock age, date of egg collection, hatchery identification, historical information about previous sets from a respective flock, and operator observation.

17. The method of claim 12, wherein candling comprises one or more of the following: measuring opacity of the eggs, measuring temperature of the eggs, spectral candling, detecting embryo pulse rate, or detecting embryo motion.

18. The method of claim 13, wherein sanitizing the in ovo processing equipment comprises applying a sanitizing fluid to the in ovo processing equipment.

19. The method of claim 12, wherein selecting a sanitizing treatment comprises selecting a sanitizing treatment with increased treatment frequency and/or duration.

20. The method of claim 12, wherein selecting a sanitizing treatment comprises selecting a sanitizing fluid with an increased concentration and/or quantity.

21. The method of claim 12, wherein selecting a sanitizing treatment comprises selecting a sanitizing fluid with an adjusted chemistry and/or adjusted temperature.

22. The method of claim 12, wherein selecting a sanitizing treatment comprises selecting a sanitizing treatment wherein sanitizing fluid is applied to shells of the set of eggs.

23. The method of claim 13, wherein processing the set of eggs via the in ovo processing equipment comprises injecting a substance into the eggs.

24. The method of claim 23, wherein the substance includes an antibiotic, and wherein selecting a sanitizing treatment comprises increasing the amount of antibiotic in the substance.

25. The method of claim 23, wherein processing the set of eggs via the in ovo processing equipment comprises extracting material from the eggs.

26. An egg processing system, comprising:
a candling apparatus that identifies live and non-live eggs in a set;
a plurality of in ovo devices configured to be inserted into the eggs;
a sanitizer configured to sanitize the plurality of in ovo devices; and
a controller in communication with the candling apparatus, in ovo devices, and sanitizer, and wherein the controller selects a sanitizing treatment for the in ovo devices based on the number of non-live eggs identified in the set.

27. The system of claim 34, wherein the candling apparatus is configured to perform at least one of the following: measure the opacity of each egg in the set, measure the temperature of each egg in the set, spectrally candle each egg in the set, detect pulse rate of each egg in the set, or detect embryo motion for each egg in the set.

28. The system of claim 26, further comprising an egg removal device operably associated with the candling apparatus that removes candled eggs designated as non-live.

29. The system of claim 26, wherein each in ovo device comprises:
a tubular punch configured to form an opening in the shell of an egg; and
a needle positioned within the tubular punch for movement therethrough and through an opening in an egg shell formed by the tubular punch for delivery of a substance into an egg and/or removal of material from an egg.

30. The system of claim 26, wherein the controller is configured to perform at least one of the following: select a sanitizing treatment with increased treatment frequency and/or duration, select a sanitizing fluid with an increased concentration and/or quantity, select a sanitizing fluid with an adjusted chemistry and/or temperature.

31. The system of claim 26, wherein the sanitizer is configured to apply sanitizing fluid to shells of the eggs.

32. The system of claim 26, wherein the plurality of in ovo devices comprise a plurality of injection devices configured to inject a substance into the eggs.

33. The system of claim 32, wherein the substance includes an antibiotic, and wherein the injection devices are configured to increase the amount of an antibiotic in the substance based on the number of non-live eggs identified in the set.

34. The system of claim 26, wherein the plurality of in ovo devices comprise a plurality of devices configured to remove material from the eggs.

35. An egg processing system, comprising:
a plurality of in ovo devices configured to be inserted into a set of eggs; and
a sanitizer configured to sanitize the plurality of in ovo devices; and
a controller in communication with the in ovo devices and sanitizer, and wherein the controller selects a sanitizing treatment for the in ovo devices based on information obtained about the set of eggs.

36. The system of claim 35, wherein each in ovo device comprises:
a tubular punch configured to form an opening in the shell of an egg; and
a needle positioned within the tubular punch for movement therethrough and through an opening in an egg shell formed by the tubular punch for delivery of a substance into an egg and/or removal of material from an egg.

37. The system of claim 35, wherein the sanitizer is configured to apply a sanitizing fluid to the plurality of injection devices.

38. The system of claim 35, wherein the controller is configured to perform at least one of the following: select a sanitizing treatment with increased treatment frequency and/or duration, select a sanitizing fluid with an increased concentration and/or quantity, select a sanitizing fluid with an adjusted chemistry and/or temperature.

39. The system of claim 35, wherein the sanitizer is configured to apply sanitizing fluid to shells of the eggs.

40. The system of claim 35, wherein the plurality of in ovo devices comprise a plurality of injection devices configured to inject a substance into the eggs.

41. The system of claim 40, wherein the substance includes an antibiotic, and wherein the injection devices are configured to increase the amount of an antibiotic in the substance based on the number of non-live eggs identified in the set.

42. The system of claim 35, wherein the plurality of in ovo devices comprise a plurality of devices configured to remove material from the eggs.
